(19) United States
(12) Patent Application Publication
(10) Pub. No.: US 2021/0305855 A1
(43) Pub. Date: Sep. 30, 2021

(54) ROTARY ELECTRIC MACHINE

(71) Applicant: AISIN SEIKI KABUSHIKI KAISHA, Kariya-shi (JP)

(72) Inventor: Masafumi SAKUMA, Kariya-shi (JP)

(73) Assignee: AISIN SEIKI KABUSHIKI KAISHA, Kariya-shi (JP)

(21) Appl. No.: 17/182,683

(22) Filed: Feb. 23, 2021

(30) Foreign Application Priority Data
Mar. 30, 2020 (JP) 2020-059414

(51) Int. Cl. H02K 1/16; H02K 3/12

(52) U.S. Cl. CPC H02K 1/165; H02K 2213/03; H02K 3/12

(57) ABSTRACT

A rotary electric machine includes: a stator having slots in each of which coils are accommodated; and a rotor having magnetic poles and facing the stator. The rotary electric machine has a fractional slot configuration. Basic phase band groups are arranged in parallel from a bottom to an opening of each slot, the basic phase band groups each including basic phase bands arranged for each pole and each having different phases in a rotation direction of the rotor, and each of the basic phase band groups is shifted by n times (n is zero or a natural number) a number of slots in a direction along the rotation direction with respect to the basic phase band group at the bottom of each slot, and, when n is an odd number, a phase band group arrangement constituted by two layers is reversed in the depth direction.

### CROSS REFERENCE TO RELATED APPLICATIONS

This application is based on and claims priority under 35 U.S.C. § 119 to Japanese Patent Application 2020-059414, filed on Mar. 30, 2020, the entire content of which is incorporated herein by reference.

### TECHNICAL FIELD

This disclosure relates to a rotary electric machine including a stator having a plurality of slots in each of which coils formed of segment conductor are accommodated, and a rotor facing the stator and having a plurality of magnetic poles.

### BACKGROUND DISCUSSION

In the related art, there is known a rotary electric machine including coils that are formed of segment conductors and have a multi-winding configuration, and having an integer slot configuration in which the number of slots per pole per phase obtained by dividing the number of slots of a stator by the number of phases and the number of magnetic poles of a rotor is a natural number (for example, see JP 2017-28847A (Reference 1)).

The rotary electric machine disclosed in Reference 1 has coil sides of first to fourth layers from an opening side of the slot toward a bottom side of each slot. The rotary electric machine includes slot conductor small groups in each of which the number of slots per pole per phase+n (n is an integer of 1 or more) of same-phase coils are arranged on the first layer and the number of slots per pole per phase−n of same-phase coils are arranged on the second layer, and other slot conductor small groups obtained by respectively shifting the slot conductor small groups in a circumferential direction of the stator in the third and the fourth layers. It is disclosed that, according to the configuration, high torque and low torque ripple can be achieved.

In addition, there is known a rotary electric machine including coils formed of a segment conductor and having a fractional slot configuration in which the number of slots per pole per phase is expressed in an irreducible fraction whose denominator is 2 or more (for example, see JP 2008-172926A (Reference 2)). The technique disclosed in Reference 2 implements a rotary electric machine having a fractional slot configuration in which segment conductors of different phases coexist in each slot by constituting the segment conductors with a wave winding configuration.

The rotary electric machine having the fractional slot configuration can implement excellent torque ripple characteristics with a small number of slots as compared with the rotary electric machine having the integer slot configuration, and thus is useful. However, the technique disclosed in Reference 1 is a rotary electric machine having the integer slot configuration, and cannot be applied to a rotary electric machine having the fractional slot configuration. In addition, the technique disclosed in Reference 2 is a rotary electric machine having the fractional slot configuration. However, the rotary electric machine adopts the wave winding configuration in which a short pitch and a long pitch are repeated, and a pair of magnetic poles adjacent to each other in a circumferential direction X have different attractive force distributions, which causes noise and vibration. Moreover, the technique disclosed in Reference 2 is premised on the wave winding configuration, and cannot be implemented by a multi-winding configuration.

A need thus exists for a rotary electric machine which is not susceptible to the drawback mentioned above.

### SUMMARY

A characteristic configuration of a rotary electric machine according to the present disclosure resides in that the rotary electric machine includes: a stator having a plurality of slots in each of which coils formed of segment conductors and having a multi-winding configuration are accommodated; and a rotor having a plurality of magnetic poles and facing the stator. The rotary electric machine having a fractional slot configuration in which the number of slots per pole per phase obtained by dividing the number of slots of the stator by the number of phases and the number of magnetic poles of the rotor is expressed as an irreducible fraction whose denominator is 2. When a circumferential direction of the stator having the same position in a depth direction in the slot is regarded as one layer, and a band of slots that are adjacent in the circumferential direction and are occupied by coil sides of the coils of the same phase having the same current direction in two layers adjacent in the depth direction is regarded as a basic phase band, a plurality of basic phase band groups are arranged in parallel from a bottom to an opening of each slot, the basic phase band groups each including basic phase bands arranged for each pole and each having different phases in a rotation direction of the rotor, and each of the basic phase band groups is shifted by n times (n is zero or a natural number) a predetermined number of slots in a predetermined direction along the rotation direction with respect to the basic phase band group at the bottom of each slot. When n is an odd number, a phase band group arrangement constituted by two layers is reversed in the depth direction.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a partially enlarged cross-sectional view of a rotary electric machine;

FIG. 2 is a schematic diagram showing phase arrangement of a basic phase band group of an 8-pole 36-slot configuration;

FIG. 3 is a schematic diagram showing a phase arrangement of basic phase band groups of an 8-pole 36-slot configuration according to the present embodiment;

FIG. 4 is an example according to the present embodiment showing a phase arrangement and a winding configuration in a U phase of the 8-pole 36-slot configuration;

FIG. 5 is a comparative example showing a phase arrangement and a winding configuration in a U phase of an 8-pole 36-slot configuration;

FIG. 6 is an example according to the present embodiment showing a phase arrangement and a winding configuration (short pitch) in the U phase of the 8-pole 36-slot configuration;

FIG. 7 is another example according to the present embodiment showing a phase arrangement and a winding configuration (short pitch) in the U phase of the 8-pole 36-slot configuration;

FIG. 8 is an example according to the present embodiment showing a phase arrangement and a winding configuration (long pitch) in the U phase of the 8-pole 36-slot configuration;

FIG. 9 is another example according to the present embodiment showing a phase arrangement and a winding configuration (long pitch) in the U phase of the 8-pole 36-slot configuration;

FIG. 10 is a schematic diagram showing a phase arrangement of a basic phase band group of an 8-pole 60-slot configuration;

FIG. 11 is an example according to the present embodiment showing a phase arrangement and a winding configuration (short pitch) in a U phase in the 8-pole 60-slot configuration;

FIG. 12 is another example according to the present embodiment showing a phase arrangement and a winding configuration (short pitch) in the U phase in the 8-pole 60-slot configuration;

FIG. 13 is an example according to the present embodiment showing a phase arrangement and a winding configuration (long pitch) in the U phase in the 8-pole 60-slot configuration;

FIG. 14 is another example according to the present embodiment showing a phase arrangement and a winding configuration (long pitch) in the U phase in the 8-pole 60-slot configuration;

FIG. 15 is a schematic diagram showing a phase arrangement and a winding configuration of a rotary electric machine in which Nspp=3.5; and

FIG. 16 is a schematic diagram showing a phase arrangement and a winding configuration of a rotary electric machine in which Nspp=4.5.

### DETAILED DESCRIPTION

Hereinafter, an embodiment of a rotary electric machine according to the present invention will be described with reference to the drawings. In the present embodiment, a three-phase AC synchronous motor (hereinafter, referred to as a motor M) will be described as an example of the rotary electric machine. However, this disclosure is not limited to the following embodiment, and various modifications can be made without departing from the scope of this disclosure.

### Basic Configuration

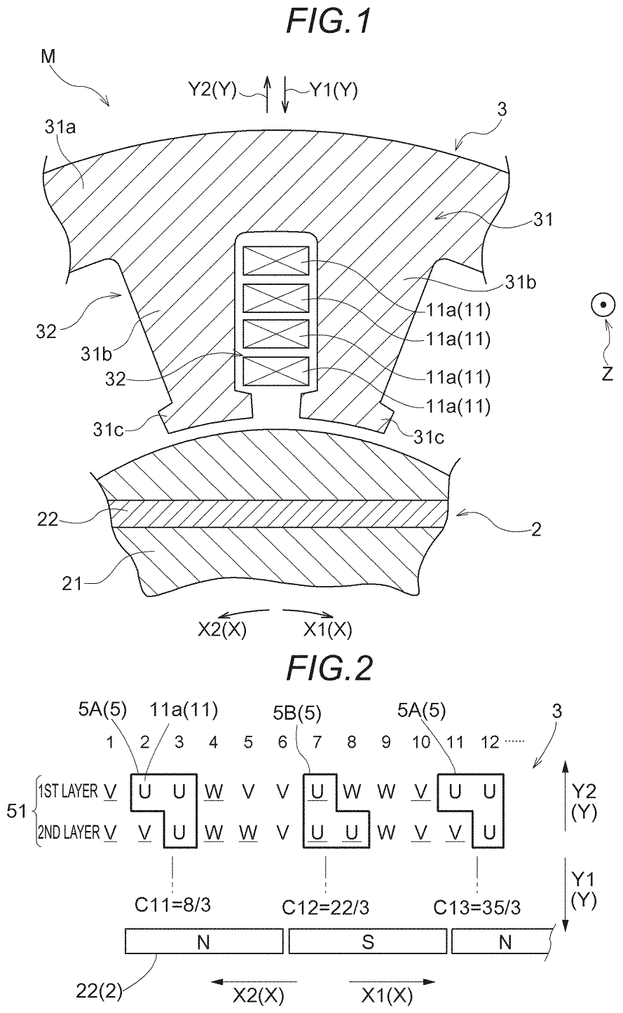

As shown in FIG. 1, the motor M includes a stator 3 having a plurality of slots 32 in each of which coil sides 11a of coils formed of segment conductors (hereinafter, referred to as a “winding”) are accommodated, and a rotor 2 having a plurality of permanent magnets 22 (an example of magnetic poles) facing the stator 3. In the following description, a rotation direction or a reverse rotation direction of the rotor 2 is referred to as a circumferential direction X, a radial direction of the rotor 2 is referred to as a radial direction Y, and a direction parallel to a rotation axis of the rotor 2 is referred to as an axial direction Z (orthogonal direction). In addition, in the circumferential direction X, a direction in which the rotor 2 rotates is referred to as a rotation direction X1, and a direction opposite thereto is referred to as a reverse rotation direction X2. In the radial direction Y, a direction from the stator 3 toward the rotor 2 (a direction toward an opening side of each slot 32) is referred to as a radially inward direction Y1, and a direction from the rotor 2 toward the stator 3 is referred to as a radially outward direction Y2 (a direction toward a bottom side of each slot 32).

The stator 3 includes a cylindrical stator core 31. The stator core 31 is formed by stacking a plurality of magnetic steel plates. The stator core 31 includes a yoke portion 31a formed in an annular shape on a radially outward direction Y2 side, a plurality of tooth portions 31b protruding from the yoke portion 31a in the radially inward direction Y1, and flange portions 31c arranged along the circumferential direction X at protruding ends of the plurality of tooth portions 31b. The slots 32 for accommodating the coil sides 11a of the coils are formed between the adjacent tooth portions 31b. The plurality of slots 32 are provided in the same number as the plurality of tooth portions 31b.

The rotor 2 includes a cylindrical rotor core 21 formed by stacking a plurality of magnetic steel plates, and the plurality of permanent magnets 22 embedded in the rotor core 21. The rotor core 21 is supported by a shaft member (not shown). The rotor 2 is rotatable relative to the stator 3 in the rotation direction X1 and the reverse rotation direction X2. The permanent magnets 22 are configured with rare earth magnets or the like. N poles and S poles are alternately arranged along the circumferential direction X. Outer circumferential surfaces of the plurality of permanent magnets 22 may be exposed from the rotor core 21.

In the motor M according to the present embodiment, a value obtained by dividing the number of slots 32 of the stator 3 by the number of phases (three phases in the present embodiment) and the number of magnetic poles of the rotor 2 (hereinafter, also referred to as the number of slots per pole per phase or Nspp) is larger than ½. When the number of slots per pole per phase is expressed as an irreducible fraction, Nspp is configured with fractional slots whose denominator is 2 or more. Hereinafter, an irreducible mixed fraction expression of the number of slots per pole per phase is a+b/c (a is an integer part, b/c is an irreducible fraction part, and b<c). Here, a is zero or a positive integer, and b and c are positive integers). For example, in an 8-pole 36-slot motor M, the number of slots per pole per phase is 3/2 (a=1, b=1, and c=2).

The windings wound around the plurality of slots 32 are configured with, for example, segment conductors in which a copper wire is covered with an insulating layer. As the windings, a square wire having a rectangular cross section, a round wire having a circular cross section, and various conductive wires having a polygonal cross section can be used. A winding method of the windings with respect to the slots 32 in the present embodiment is multi-winding.

As shown in FIG. 1, in each of the coils of each phase (U phase, V phase, W phase), the plurality of coil sides 11a of the coils are stacked in each slot 32 along the radial direction Y. In the case of the fractional slot, a plurality of sets of two-layer units (basic phase bands 5 to be described later) each including two coil sides 11a stacked in the radial direction Y are included (for example, four sets in which a first layer and a second layer in FIG. 2 are repeated in the radial direction Y). The coils of the three phases are electrically connected into a Y connection. The three-phase coils may be electrically connected into a Δ connection, and are not particularly limited. The “layers” denoted by the same reference numerals are continuous in the rotation direction X1 of the rotor 2 at the same position in a depth direction of the slots 32 (radial direction Y).

In the case of the multi-winding in the fractional slot, a coil pitch is preferably an integer closest to the number of slots per pole obtained by dividing the number of slots 32 of the stator 3 by the number of magnetic poles of the rotor 2. For example, in the case of the 8-pole 36-slot motor M (the number of slots per pole is 4.5), the coil pitch is 4 slots as for a short pitch (short-pitch winding) or 5 slots as for a long pitch (long-pitch winding).

FIG. 2 shows a basic form of a magnetic pole facing state between a phase arrangement of the coil sides 11a of the winding wound around the plurality of slots 32 and a pair of magnetic poles (N pole and S pole) of the rotor 2 in the 8-pole 36-slot motor M. FIG. 2 is a linear expression of FIG. 1 for the sake of convenience (a radially inner side is expanded for convenience). The yoke portion 31a, the tooth portions 31b, and the windings are not shown in FIG. 2. Serial numbers shown in an upper part of FIG. 2 indicate slot numbers of the slots 32. U phase coils, V phase coils, and W phase coils are shifted in phase by 120° in this order in terms of electrical angle in the rotation direction X1. Hereinafter, since each phase (U phase, V phase, and W phase) has the same phase arrangement except for the phase shift, the U phase coil will be described as a representative. In the drawings, the notation of “U” and the notation of “U” with an underline indicate that current directions are opposite to each other. The same notation indicates that the coil sides 11a have the same current direction. In addition, in the radial direction Y, the first layer, the second layer, . . . are expressed in order from the coil side 11a located in the most radially outward direction Y2 to the coil side 11a located in the radially inward direction Y1.

A set of coil sides 11a, which are accommodated in one or a plurality of adjacent slots 32 having the same phase and the same current direction for each pole of the magnetic pole of the rotor 2 and are formed of two layers adjacent to each other in the radial direction Y, is defined as a basic phase band 5. In other words, a band of the slots 32 that are adjacent in the circumferential direction X of the stator 3 and are occupied by the coil sides 11a of the coil of one phase having the same current direction in two layers adjacent in the depth direction of the slots 32 (radial direction Y) is regarded as the basic phase band 5, in which the circumferential direction X having the same position in the depth direction (radial direction Y) is regarded as the same layer. Each basic phase band 5 accommodates the coil sides 11a forming one turn of the number of windings of the phase in the coil. Here, “a set of the coil sides 11a, which are accommodated in one or a plurality of adjacent slots 32 having the same phase and the same current direction for each pole” is synonymous with a set of the coil sides 11a having the same phase and the same current direction and accommodated in one slot 32 or a plurality of slots 32 (two in the case of the 8-pole 36-slot motor M) continuously adjacent in the circumferential direction X.

In the 8-pole 36-slot fractional slot configuration (Nspp=3/2, a=1, b=1, and c=2), the basic phase bands 5 are constituted by first pole basic phase bands 5A and second pole basic phase bands 5B respectively facing pairs of adjacent magnetic poles (two poles) among the plurality of magnetic poles (eight poles in the case of the 8-pole 36-slot configuration). The first pole basic phase bands 5A and the second pole basic phase bands 5B are different from each other in the phase arrangement, and are basic phase bands 5 whose distribution is not uniform.

In the case of the basic form motor M including only the first layer and the second layer shown in FIG. 2, the plurality of (three) coil sides 11a of the basic phase band 5 arranged in the second slot to the third slot are one in the second slot and two in the third slot. A center position C11 of the plurality of coil sides 11a of the basic phase band 5 is expressed using the slot number for the sake of convenience (that is, a coil side center position is numerically expressed with the center in the circumferential direction of the slot number 1 as a reference position and with the slot pitch as 1) (the same applies to the following). The center position C11 is 8/3 as shown in the following Formula (1).

C11=(2×1+3×2)/(1+2)=8/3 Formula (1)

Similarly, a center position C12 of the plurality of (three) coil sides 11a of the basic phase band 5 arranged in the seventh slot to the eighth slot is 22/3 as shown in the following Formula (2). A center position C13 of the plurality of (three) coil sides 11a of the basic phase band 5 arranged in the 11th slot and the 12th slot is 35/3 as shown in the following Formula (3).

C12=(7×2+8×1)/(2+1)=22/3 Formula (2)

C13=(11×1+12×2)/(1+2)=35/3 Formula (3)

Based on the above calculation results, in the case of the basic form motor M including only the first layer and the second layer, distances between the centers of the coil sides 11a of the basic phase band 5 of the U phase are C12−C11=14/3, and C13×C12=13/3, and 14/3 and 13/3 are repeated alternately. That is, the distances between the centers of the coil sides 11a of the basic phase bands 5 of the same phase adjacent in the circumferential direction X are not uniform at every pole. Therefore, the pairs of magnetic poles adjacent to each other in the circumferential direction X have different attractive force distributions. The attractive force distributions acting on the plurality of tooth portions 31b are not equivalent for each magnetic pole but equivalent for each magnetic pole pair (for each two magnetic poles) at separated poles. The two types of attractive force distributions include, for the stator 3, a component of a vibration causing force of a lower order (in the present embodiment, a fourth order of a spatial deformation mode) than an order based on the number of magnetic poles (in the present embodiment, eight poles) of the rotor 2 (in the present embodiment, an eighth order of the spatial deformation mode). As a result, the vibration causing force in the low order spatial deformation mode of an order lower than the number of magnetic poles of the rotor 2 is more likely to be generated than the number of magnetic poles of the rotor 2. The noise and the vibration become large in a rotation rate region in which a natural frequency of the stator 3 corresponding to the spatial deformation mode in the lower order and a frequency of the vibration causing force in the spatial deformation mode in the lower order coincide with each other.

In the case of the basic form motor M including only the first layer and the second layer, the number of the plurality of coil sides 11a constituting each basic phase band 5 of the U phase is equal in each pole (three). Therefore, a magnitude of a magnetomotive force generated when the winding of the stator 3 is energized is equal in each pole. However, as described above, a 1/2 series (c=2) motor M has two types of magnetomotive force distributions. Therefore, in the present embodiment, even if the magnitude of the magnetomotive force is uniform, the noise and the vibration of the motor M caused by the phase arrangement of the windings of the stator 3 are reduced by improving a state in which the magnetomotive force distributions are not uniform (a state without rotational symmetry for each pole).

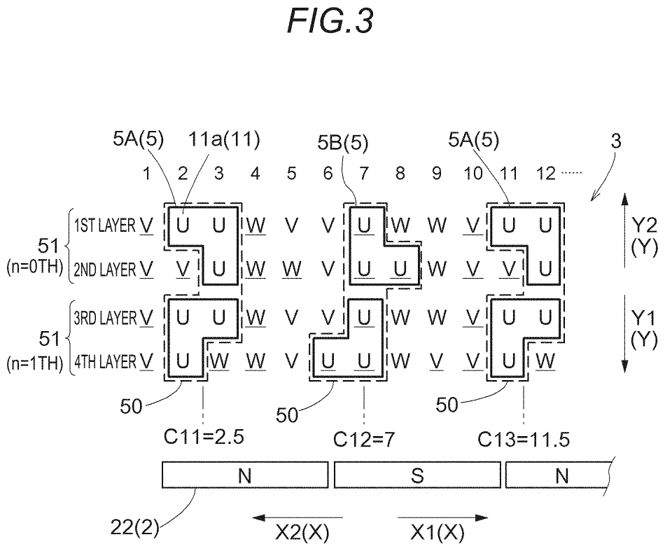

Therefore, in the present embodiment, a plurality of basic phase band groups 51 having different phases in the rotation direction X1, in which the basic phase bands 5 are arranged for each pole, are arranged in parallel from the bottom to the opening of each slot 32 (from the bottom of the slot 32 in the radially inward direction Y1). Each basic phase band group 51 is shifted by n times (n is zero or a natural number) a predetermined number of slots in a predetermined direction along the rotation direction X1 with respect to the basic phase band group 51 at the bottom of each slot 32 (n=0). Here, the predetermined direction may be the rotation direction X1 or the reverse rotation direction X2. In addition, it is preferable that the basic phase band groups 51 are arranged in parallel in the depth direction (radial direction Y) from the bottom to the opening of the slot 32 such that n is in an ascending order or a descending order (in the present embodiment, ascending order). In the case of the fractional slot, the predetermined number of slots is an integer (3×Nspp±1/c) closest to a value (the number of slots per pole) obtained by multiplying the number of slots per pole per phase by three (by the number of phases). In the 8-pole 36-slot fractional slot configuration (Nspp=3/2, a=1, b=1, and c=2), the predetermined number of slots is 4 slots or 5 slots, and is 4 slots (short pitch) in the example of FIG. 3.

Furthermore, although details will be described later, in the present embodiment, in order to implement the multi-winding configuration of the coils constituted by the segment conductor, when n is an odd number, the phase band group arrangement constituted by two layers is reversed in the depth direction (radial direction Y). In the example of FIG. 3, in the basic phase band group 51 of n=1 (odd number) is obtained by shifting the basic phase band group 51 of n=0 in the rotation direction X1 by four slots and reversing the first layer and the second layer thereof in the radial direction Y. In addition, a mixed phase band 50 in which (n+1) (here, two) basic phase bands 5 are stacked from the radially outward direction Y2 of the slots 32 toward the radially inner direction Y1 is arranged for each pole.

In the embodiment shown in FIG. 3, the plurality of (six) coil sides 11a of the mixed phase band 50 arranged in the second slot and the third slot include three in the second slot and three in the third slot. The center position C11 of the plurality of coil sides 11a of the mixed phase band 50 is 2.5 as shown in the following Formula (4).

C11=(2×3+3×3)/(3+3)=2.5 Formula (4)

Similarly, the center position C12 of the plurality of (six) coil sides 11a of the mixed phase band 50 arranged in the sixth slot to the eighth slot is 7 as shown in the following Formula (5). The center position C13 of the plurality of (six) coil sides 11a of the mixed phase band 50 arranged in the 11th slot and the 12th slot is 11.5 as shown in the following Formula (6).

C12=(6×1+7×4+8×1)/(1+4+1)=7 Formula (5)

C13=(11×3+12×3)/(3+3)=11.5 Formula (6)

The number of the plurality of coil sides 11a constituting each of the mixed phase bands 50 of the U phase is six, which is uniform in each pole. Therefore, the magnitude of the magnetomotive force generated when the winding of the stator 3 is energized is uniform in each pole. Further, C12−C11=4.5 and C13−C12=4.5 are satisfied. The distances between the centers of the coil sides 11a of the mixed phase bands 50 of the same phase (U phase) adjacent in the circumferential direction X are equal in each pole. As a result, the magnetomotive force distribution is closer to equivalent in each pole. The motor M according to the present embodiment can be regarded as closer to a state of having the same type of magnetomotive force distribution.

As described above, in the present embodiment, the rotational symmetry of the magnetomotive force distribution at each pole is improved. As a result, in the motor M according to the present embodiment, the vibration causing force of the low order (the fourth order of the spatial deformation mode) is reduced as compared with the order based on the number of magnetic poles (eight poles) of the rotor 2 (the eighth order of the spatial deformation mode). Therefore, the rotation rate that coincides with the natural frequency of the stator core 31 increases, and can be set, for example, outside a use rotation rate range. That is, the motor M according to the present embodiment can reduce the noise and the vibration of the motor M by avoiding a resonance opportunity of the rotor 2 within the use rotation rate range.

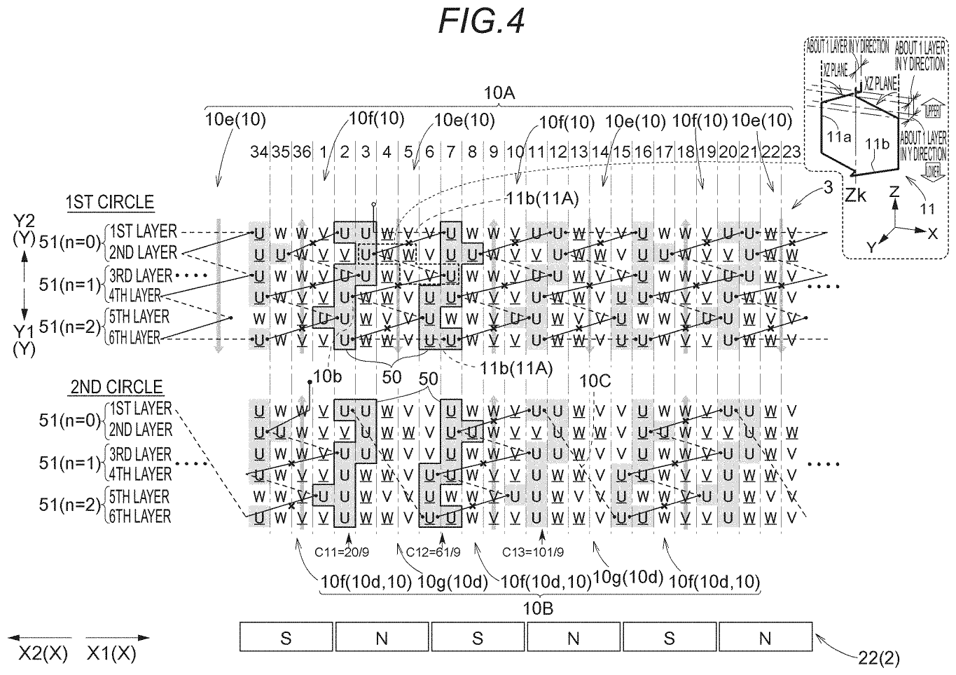

Next, with reference to FIGS. 4 to 9, an example of the phase band group arrangement of the basic phase band groups 51 for implementing the multi-winding configuration of the coils constituted by the segment conductor will be described. In these drawings, the U phase multi-winding is shown as an example of a winding method for the slots 32 of the winding in the case of the 8-pole 36-slot motor M (Nspp=1.5, a=1, b=1, and c=2). The upper numbers in the drawings indicate the slot numbers. A white circle (see FIG. 4) in the drawings connected to the radially outermost side of the second slot indicates a winding start terminal. A black circle (see FIG. 4) in the drawing connected to the radially outermost side of the 35th slot indicates a winding end terminal. In addition, a cross mark in the drawings indicates a unit coil connection portion in which a pair of unit coils 11 are electrically connected by welding or the like. A solid line indicates a coil end arranged on an upper surface (a front side of a paper surface) of the stator 3. A broken line indicates a coil end arranged on a lower surface (a back side of the paper surface) of the stator 3.

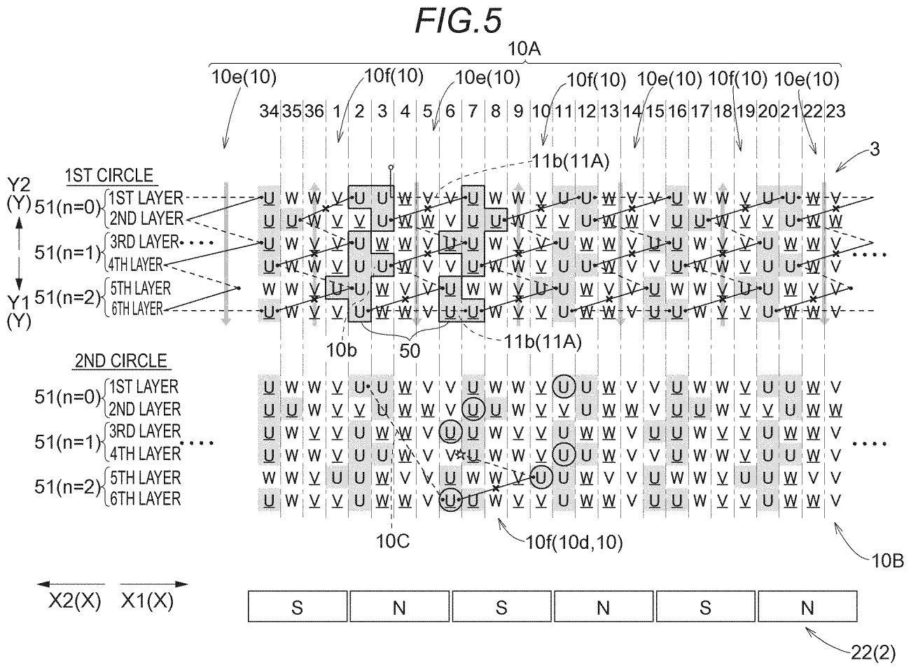

As described above, in the example according to the present embodiment, each of the basic phase band groups 51 is shifted by n times (n is zero or a natural number) the predetermined number of slots in the predetermined direction along the rotation direction X1 with respect to the basic phase band group 51 at the bottom of each slot 32 (n=0). When n is an odd number, the phase band group arrangement constituted by two layers is reversed in the depth direction (the radial direction Y) (see FIG. 4). On the other hand, in a comparative example, each of the basic phase band groups 51 is shifted by n times (n is zero or a natural number) the predetermined number of slots in the predetermined direction along the rotation direction X1 with respect to the basic phase band group 51 at the bottom of each slot 32 (n=0). When n is an odd number, the phase band group arrangement constituted by two layers is not reversed in the depth direction (the radial direction Y) (see FIG. 5).

As shown in FIGS. 4 and 6 to 9, as the multi-winding configuration of the coils constituted by the segment conductor in the example according to the present embodiment, each of a circles of coils (one circle, since a=1) is constituted by an adjacent pole coil group 10A in which pole coils 10 having the same phase at each pole of the magnetic poles of the rotor 2 and having opposite current directions at the adjacent poles of the magnetic poles of the rotor 2, that is, having the same current direction at separated poles (separated by one pole) of the magnetic poles of the rotor 2 are electrically connected in a state of being arranged adjacent to each other. In other words, each of a circles of coils is constituted by the adjacent pole coil group 10A that makes one circle and in which, in a state in which a number of pole coils 10 the same as the number of magnetic poles of the rotor 2 are arranged adjacent to each other on an entire circumference of the stator 3, the pole coils 10 adjacent in the circumferential direction X are sequentially and electrically connected. Here, a circling direction of the a circles of coils is the same. In addition, an (a+1)th circle of coils ((a+1)=2) includes a separated pole coil group 10B in which the number of magnetic poles (8 poles) in the circumferential direction X/c (four, since c=2) of continuous pole coils 10d each including b (b=1) pole coils 10 electrically connected to face c (c=2) magnetic poles are arranged in the circumferential direction X at separated poles. The continuous pole coils 10d adjacent in the circumferential direction X are electrically connected by separation pole coil connection portions 10C. Here, the “separated poles” means non-adjacent magnetic poles arranged in the circumferential direction X with one or more magnetic poles interposed therebetween. In other words, the (a+1)th circle of the coils is constituted by the separated pole coil group 10B in which each range obtained by equally dividing the entire circumference of the stator 3 into the number of magnetic poles (8 poles)/c (four, since c=2) is provided with one continuous pole coil 10d in which b (b=1) pole coils 10 and (c−b) (c−b=1) pole coil missing portions 19g formed of blanks corresponding to the pole coils 10 are sequentially adjacent to each other and the pole coils 10 closest to each other in the circumferential direction are electrically connected, and the number of magnetic poles/c (four, since c=2) of the continuous pole coils 10d adjacent in the circumferential direction are sequentially and electrically connected so as to circle. Here, when each continuous pole coil 10d includes two or more pole coils 10, the pole coils 10 closest to each other and adjacent in the circumferential direction X are sequentially and electrically connected. In the separated pole coil group 10B, the number of magnetic poles/c (four, since c=2) of the continuous pole coils 10d are arranged at an equal pitch in the circumferential direction X. The continuous pole coils 10d are electrically connected by the separation pole coil connection portions 10C. As described above, the adjacent pole coil groups 10A of the a circles and the separated pole coil group 10B of the (a+1)th circle are connected in series to form a phase coil.

As shown in FIG. 4, each unit coil 11 constituted by the segment conductor includes the pair of coil sides 11a accommodated in two slots 32, and one turn coil end 11b that electrically connects the pair of coil sides 11a and is arranged at the coil end. The turn coil end 11b in the present example means a coil end that electrically connects the coil sides 11a having the same winding order as viewed from a phase start terminal. The unit coil connection portion indicated by the cross mark in FIG. 4 indicates coil ends (coil ends connecting one turn) electrically connecting the coil sides 11a whose turn orders are shifted from each other by one turn. For convenience of description, the unit coil connection portion is not included in the turn coil end 11b.

As an example of the unit coils 11 of the pole coils 10, a pair of linear coil sides 11a are connected to both ends of the turn coil end 11b having a short pitch. The turn coil end 11b is bent in the radially outward direction Y2 at a central portion (a reference position Zk) extending from one end (left side in FIG. 4) by a slot pitch of a short pitch/2, and is bent in the radially inward direction Y1 at the other end (right side in FIG. 4) extending from the central portion. In the unit coils 11 of the pole coils 10, the coil sides 11a are inserted into the second layer of the second slot and the third layer of the sixth slot such that the turn coil end 11b serving as one coil end is arranged on a lower side of the stator 3. Then, the linear winding including the coil side 11a connected to one end of the turn coil end 11b is bent inward in the turn, and the linear winding including the coil side 11a connected to the other end of the turn coil end 11b is bent inward in the turn to form the other coil end. A coil end located on one end side of the turn coil end 11b of a second turn is connected to a coil end located on the other end side of the turn coil end 11b of a first turn by welding or the like. A coil end located on the other end side of the turn coil end 11b of the second turn is connected to a coil end located on one end side of the turn coil end 11b of the third turn by welding or the like. Accordingly, the turn coil ends 11b other than the same-layer connection portion are inclined or bent by one layer from a radially outer side to a radially inner side in the rotation direction X1.

In each adjacent pole coil group 10A constituting the a circles (a=1) of coils, first pole coils 10e including the turn coil ends 11b connecting the same layer in the radial direction Y of the slots 32 and second pole coils 10f without the turn coil ends 11b connecting the same layer in the radial direction Y of the slots 32 are alternately arranged adjacent to one another in the circumferential direction X. That is, in the adjacent pole coil group 10A, the first pole coils 10e including the turn coil ends 11b connecting the same layer in the radial direction Y of the slots 32 are arranged for each separation pole separated by one pole, and the second pole coils 10f without the turn coil ends 11b connecting the same layer in the radial direction Y of the slots 32 are arranged for each separation pole separated by one pole. Here, “the first pole coils 10e including the turn coil ends 11b connecting the same layer in the radial direction Y of the slots 32” refers to the pole coils 10 having the coil ends (the turn coil ends 11b) connecting the coil sides 11a of the same phase arranged in the first layer (or the eighth layer) in the same layer as shown in FIG. 4.

Further, the turn coil ends 11b connecting the same layer in the radial direction Y of the slots 32 are arranged on a radially outermost side which is the most radially outward direction Y2 of the slots 32 and on the radially innermost side which is the most radially inward direction Y1 of the slots 32.

In the separated pole coil group 10B of the (a+1)th circle ((a+1)=2), when the numbers of blanks between the pole coils 10 are all odd numbers (1), the continuous pole coils 10d each constituted only by b (b=1) second pole coils 10f without the turn coil ends 11b connecting the same layer in the radial direction Y of the slots 32 are arranged by the number of magnetic poles (8 poles)/c (four, since c=2) separated by one pole in the circumferential direction X. The separation pole coil connection portions 10C electrically connect the number of magnetic poles (8 poles)/c (four, since c=2) of the continuous pole coils 10d. When the number of the blanks is an odd number (1), the separation pole coil connection portion 10C that spans the blanks electrically connects the first layer on the radially outermost side, which is the most radially outward direction Y2 of the slots 32, and the eighth layer on the radially innermost side, which is the most radially inward direction Y1.

Summarizing the above, in the phase coil configuration according to the example in the present embodiment, the configuration in which the pole coils 10 adjacent in the circumferential direction X are electrically connected to each other by adjacent pole coil connection portions 11A make a circles in the rotation direction X1, and subsequently, b continuous pole coils 10d are electrically connected by the separated pole coil connection portion 10C while skipping (c−b) poles per c continuous poles, and make one circle in the rotation direction X1. According to the configuration, the adjacent pole coil groups 10A of the second and subsequent circles or the separated pole coil group 10B is shifted by one slot pitch in the direction opposite to the circling direction (rotation direction X1) (reverse rotation direction X2) with respect to the adjacent pole coil group 10A on a previous circle.

According to the above specification, since the turn coil ends 11b other than the same-layer connection portion are inclined or bent by one layer from the radially outer side to the radially inner side in the rotation direction X1, the unit coil connection portion in which the pair of unit coils 11 are electrically connected by welding or the like can be visually recognized without interfering with other coils. Accordingly, after all the coil sides 11a of the unit coils 11 constituted by the three-phase segment conductor of the U phase, the V phase, and the W phase are inserted into the slots 32, work of connecting the pair of unit coils 11 by welding or the like becomes extremely easy.

On the other hand, in the comparative example shown in FIG. 5, each of the basic phase band groups 51 is shifted by n times (n is zero or a natural number) the predetermined number of slots in the predetermined direction along the rotation direction X1 with respect to the basic phase band group 51 at the bottom of each slot 32 (n=0). When n is an odd number, the phase band group arrangement constituted by two layers is not reversed in the depth direction (the radial direction Y). In this case, in the separated pole coil group 10B of the (a+1)th circle ((a+1)=2), since the V phase is arranged in the fourth layer of the fifth slot in the continuous pole coils 10d constituted only by the second pole coils 10f, the slot pitch of the turn coil ends 11b other than the same-layer connection portion is not inclined by one layer from the radially outer side to the radially inner side. When the third layer of the fifth slot and the fifth layer of the ninth slot are connected and the second layer of the sixth slot and the fourth layer of the tenth slot are connected, the turn coil ends 11b of the unit coils 11 become complicated in the vicinity of the fourth layer, which causes a problem in accommodation of the coil ends.

In the example shown in FIG. 4, the plurality of (nine) coil sides 11a of the mixed phase band 50 arranged in the first slot to the third slot include one in the first slot, five in the second slot, and three in the third slot. The center position C11 of the plurality of coil sides 11a of the mixed phase band 50 is 20/9 as shown in the following Formula (7).

C11=(1×1+2×5+3×3)/(1+5+3)=20/9 Formula (7)

Similarly, the center position C12 of the plurality of (nine) coil sides 11a of the mixed phase band 50 arranged in the sixth slot to the eighth slot is 61/9 as shown in the following Formula (8). The center position C13 of the plurality of (nine) coil sides 11a of the mixed phase band 50 arranged in the 10th slot to the 12th slot is 101/9 as shown in the following Formula (9).

C12=(6×3+7×5+8×1)/(3+5+1)=61/9 Formula (8)

C13=(10×1+11×5+12×3)/(1+5+3)=101/9 Formula (9)

The number of the plurality of coil sides 11a constituting each of the mixed phase bands 50 of the U phase is nine, which is uniform in each pole. Therefore, the magnitude of the magnetomotive force generated when the winding of the stator 3 is energized is uniform in each pole. Further, C12−C11=41/9 and C13−C12=40/9 are satisfied. The distance between the centers of the coil sides 11a of the mixed phase bands 50 of the same phase (U phase) adjacent in the circumferential direction X is improved as compared with the case of the basic form motor M including only the first layer and the second layer (C12−C11=14/3, C13−C12=13/3). Therefore, the magnetomotive force distribution is improved so as to be closer to equivalent at each pole.

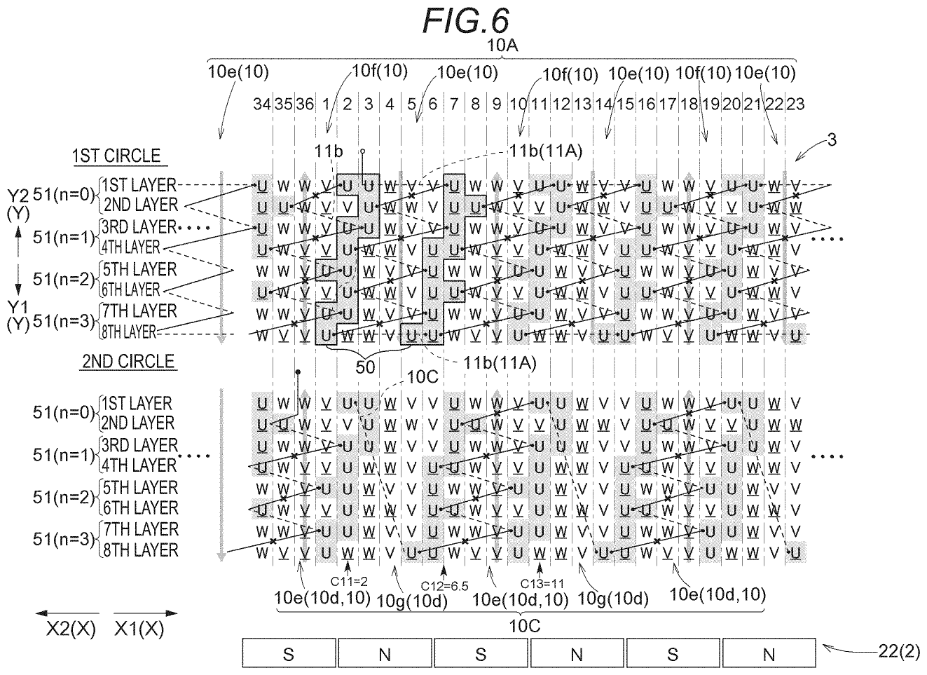

FIG. 6 shows another example according to the present embodiment, which is constituted by eight layers of the coil sides 11a (four basic phase band groups 51) in the 8-pole 36-slot motor M (Nspp=1.5, a=1, b=1, and c=2). Also in this case, as in the example shown in FIG. 4, in each adjacent pole coil group 10A constituting the a circles of coils, first pole coils 10e including the turn coil ends 11b connecting the same layer in the radial direction Y of the slots 32 and second pole coils 10f without the turn coil ends 11b connecting the same layer in the radial direction Y of the slots 32 are alternately arranged adjacent to one another in the circumferential direction X. In the separated pole coil group 10B of the (a+1)th circle ((a+1)=2), the continuous pole coils 10d constituted only by b (b=1) second pole coils 10f without the turn coil ends 11b connecting the same layer in the radial direction Y of the slots 32 are arranged by the number of magnetic poles (8 poles)/c (four, since c=2) separated by one pole in the circumferential direction X. The separated pole coil connection portion 10C electrically connects the number of magnetic poles (8 poles)/c (four, since c=2) of the continuous pole coils 10d.

The plurality of coil sides 11a of the mixed phase band 50 arranged in the first slot to the third slot include three in the first slot, six in the second slot, and three in the third slot. The center position C11 of the plurality of coil sides 11a of the mixed phase band 50 is 2 as shown in the following Formula (10).

C11=(1×3+2×6+3×3)/(3+6+3)=2 Formula (10)

Similarly, the center position C12 of the plurality of coil sides 11a of the mixed phase band 50 arranged in the fifth slot to the eighth slot is 6.5 as shown in the following Formula (11). The center position C13 of the plurality of coil sides 11a of the mixed phase band 50 arranged in the 10th slot to the 12th slot is 11 as shown in the following Formula (12).

C12=(5×1+6×5+7×5+8×1)/(1+5+5+1)=6.5 Formula (11)

C13=(10×3+11×6+12×3)/(3+6+3)=11 Formula (12)

The number of the plurality of coil sides 11a constituting each of the mixed phase bands 50 of the U phase is 12, which is uniform in each pole. Therefore, the magnitude of the magnetomotive force generated when the winding of the stator 3 is energized is uniform in each pole. Further, C12−C11=4.5 and C13−C12=4.5 are satisfied. The distances between the centers of the coil sides 11a of the mixed phase bands 50 of the same phase (U phase) adjacent in the circumferential direction X are equal in each pole. As a result, the magnetomotive force distribution is closer to equivalent at each pole. The motor M according to the present example can be regarded as closer to a state in which one type of magnetomotive force distribution is provided.

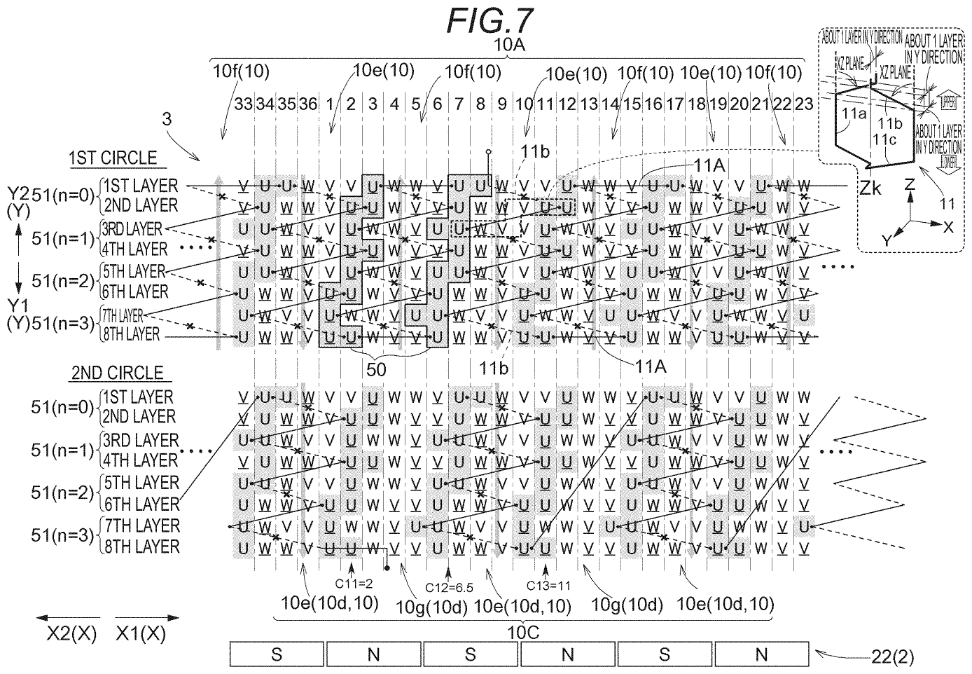

FIG. 7 shows an example of a winding configuration different from that of FIG. 6 in the multi-winding configuration of the coils constituted by the segment conductor according to the present embodiment. In FIG. 7, the phase band arrangement is formed by switching two layers of each of the four sets of the basic phase band groups 51 shown in FIG. 6 in the radial direction Y.

In the present example, in each adjacent pole coil group 10A constituting the a circles (a=1) of coils, the first pole coils 10e which are arranged on the radially outermost side which is the most radially outward direction Y2 of the slots 32 and on the radially innermost side which is the most radially inward direction Y1 of the slots 32 and are not interposed between the pair of adjacent pole coil connection portions 11A electrically connecting the adjacent pole coils 10 and the second pole coils 10f interposed between the pair of adjacent pole coil connection portions 11A are alternately arranged in the circumferential direction X. That is, in the adjacent pole coil group 10A, the first pole coils 10e including only the pole coils 10 without the adjacent pole coil connection portion 11A that connects the same layer in the radial direction Y of the slots 32 are arranged for each separated pole separated by one pole, and the second pole coils 10f including the adjacent pole coil connection portion 11A that connects the same layer in the radial direction Y of the slots 32 are arranged for each separated pole separated by one pole.

The separated pole coil group 10B of the (a+1)th circle ((a+1)=2) includes only the first pole coils 10e that are not interposed between the pair of adjacent pole coil connection portions 11A. A plurality of continuous pole coils 10d constituted only by b (b=1) first pole coils 10e not interposed between the pair of adjacent pole coil connection portions 11A are arranged to be separated by one pole in the circumferential direction X. The separated pole coil connection portion 10C electrically connects the number of magnetic poles (8 poles)/c (four, since c=2) of the continuous pole coils 10d. The separated pole coil connection portion 10C electrically connects the eighth layer on the radially innermost side, which is the most radially inward direction Y1 of the slots 32, and the first layer on the radially outermost side, which is the most radially outward direction Y2 of the slots 32.

The unit coils 11 constituted by the segment conductor include the pair of coil sides 11a accommodated in two slots 32, and one turn coil end 11b that electrically connects the pair of coil sides 11a and is arranged at the coil end. The turn coil end 11b in the present example means a coil end in which the coil sides 11a having the same winding order are electrically connected. The coil end indicated by a broken line including the unit coil connection portion indicated by the cross mark in FIG. 7 is the turn coil end 11b electrically connected in the same turn order. The coil end indicated by a solid line electrically connecting the coil sides 11a having the turn orders shifted from each other by one is not the turn coil end 11b. That is, in the unit coils 11, a coil end (coil side connection portion 11c) in which the pair of coil sides 11a are connected in advance is not included in the turn coil end 11b for convenience of description.

As an example of the unit coils 11 of the pole coils 10, in the unit coils 11 of the pole coils 10 except for the adjacent pole coil connection portion 11A, a pair of linear coil sides 11a are connected to both ends of the coil side connection portion 11c having a long pitch. In addition, the coil side connection portion 11c is bent in the radially outward direction Y2 at the central portion (the reference position Zk) extending from one end (left side in FIG. 7) in the rotation direction X1 by a slot pitch of a long pitch/2. In the unit coils 11 of the pole coils 10, the coil side 11a is inserted into the third layer of the sixth slot and the second layer of the 11th slot such that the coil side connection portion 11c serving as one coil end is arranged on the upper side (the front side of the paper surface) of the stator 3. Then, the linear winding including the coil side 11a connected to one end of the coil side connection portion 11c is bent inward in the turn, and the linear winding including the coil side 11a connected to the other end (right side in FIG. 7) of the coil side connection portion 11c is bent inward in the turn to form the other coil end. The coil end formed by bending the linear winding including the first coil side 11a of the second turn, which is located at one end side (left side in FIG. 7) of the coil side connection portion 11c that connects the second coil side 11a of the first turn and the first coil side 11a of the second turn when viewed from the beginning of the phase, inward of the turn connects, by welding or the like, with the coil end formed by bending the linear winding including the second coil side 11a of the second turn, which is located at the other end side (right side in FIG. 7) of the coil side connection portion 11c that connects the second coil side 11a of the second turn and the first coil side 11a of the third turn, inward of the turn to form the turn coil end 11b of the second turn. The coil end formed by bending the linear winding including the second coil side 11a of the first turn, which is located on the other end side (right side in FIG. 7) of the coil side connection part 11c that connects the second coil side 11a of the first turn and the first coil side 11a of the second turn when viewed from the beginning of the phase, inward of the turn, at a segment conductor side for half a turn connected to the beginning of the phase, connects, by welding or the like, with the turn coil end 11b formed by bending the linear winding including the first coil side 11a of the first turn inward of the turn to form the turn coil end 11b for one turn. Accordingly, the turn coil ends 11b other than the same-layer connection portion are inclined or bent by one layer from a radially outer side to a radially inner side in the rotation direction X1.

According to the above specification, since the turn coil ends 11b other than the same-layer connection portion are inclined or bent by one layer from the radially outer side to the radially inner side in the rotation direction X1, the unit coil connection portion in which the pair of unit coils 11 are electrically connected by welding or the like can be visually recognized without interfering with other coils. Accordingly, after all the coil sides 11a of the unit coils 11 constituted by the three-phase segment conductor of the U phase, the V phase, and the W phase are inserted into the slots 32, work of connecting the pair of unit coils 11 by welding or the like becomes extremely easy.

In the phase band arrangement according to the example shown in FIG. 7, as in the example shown in FIG. 6, C12−C11=4.5 and C13−C12=4.5 are satisfied. The distances between the centers of the coil sides 11a of the mixed phase bands 50 of the same phase (U phase) adjacent in the circumferential direction X are equal in each pole.

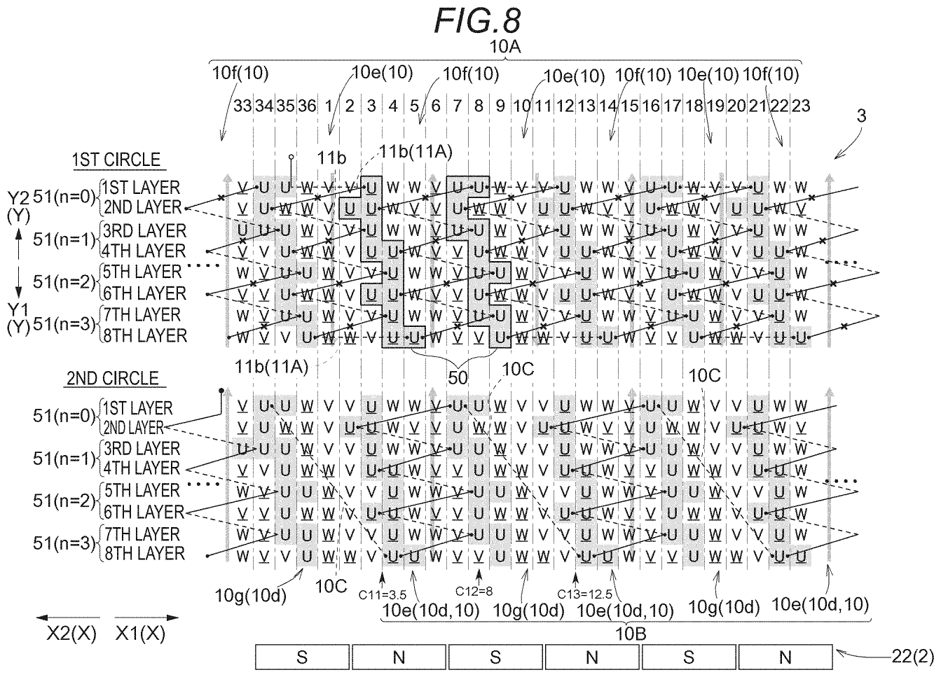

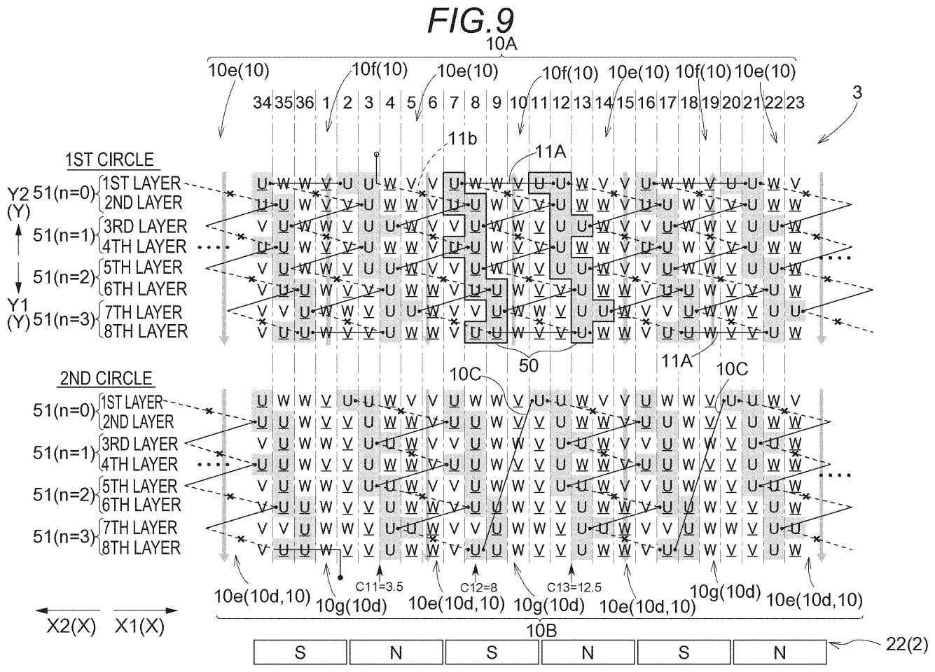

FIG. 8 shows an example in which the winding configuration shown in FIG. 6 (most turn coil end pitches are the long pitch) is adopted in the phase band arrangement shown in FIG. 7 (the turn coil end pitch is substantially half the short pitch and half the long pitch). In addition, FIG. 9 shows an example (the turn coil end pitch is substantially half the short pitch and half the long pitch) in which the winding configuration shown in FIG. 7 is adopted in the phase band arrangement shown in FIG. 6.

In any of the cases shown in FIGS. 8 and 9, the a circles (one circle, since a=1) of coils are constituted by the adjacent pole coil groups 10A in each of which the pole coils 10 having the same phase at each pole of the magnetic poles of the rotor 2 and having the opposite current directions at the adjacent poles of the magnetic poles of the rotor 2, that is, having the same current direction at separated poles (separated by one pole) of the magnetic poles of the rotor 2 are electrically connected in the state of being arranged adjacent to each other. In addition, the (a+1)th circle ((a+1)=2) of the coils includes the separated pole coil group 10B in which the number of magnetic poles (8 poles) in the circumferential direction X/c (four, since c=2) of the continuous pole coils 10d including b (b=1) pole coils 10 electrically connected to face c (c=2) magnetic poles are arranged in the circumferential direction X at the separated poles. Each of the continuous pole coils 10d adjacent in the circumferential direction X is electrically connected by a separated pole coil connection portion 10C.

In any of the cases shown in FIGS. 8 and 9, the plurality of coil sides 11a of the mixed phase band 50 arranged in the second slot to the fifth slot are one in the second slot, five in the third slot, five in the fourth slot, and one in the fifth slot. The center position C11 of the plurality of coil sides 11a of the mixed phase band 50 is 3.5 as shown in the following Formula (13).

C11=(2×1+3×5+4×5+5×1)/(1+5+5+1)=3.5 Formula (13)

Similarly, the center position C12 of the plurality of coil sides 11a of the mixed phase band 50 arranged in the seventh slot to the ninth slot is 8 as shown in the following Formula (14). The center position C13 of the plurality of coil sides 11a of the mixed phase band 50 arranged in the 11th slot to the 14th slot is 12.5 as shown in the following Formula (15).

C12=(7×3+8×6+9×3)/(3+6+3)=8 Formula (14)

C13=(11×1+12×5+13×5+14×1)/(1+5+5+1)=12.5 Formula (15)

The number of the plurality of coil sides 11a constituting each of the mixed phase bands 50 of the U phase is 12, which is uniform in each pole. Therefore, the magnitude of the magnetomotive force generated when the winding of the stator 3 is energized is uniform in each pole. Further, C12−C11=4.5 and C13−C12=4.5 are satisfied. The distances between the centers of the coil sides 11a of the mixed phase bands 50 of the same phase (U phase) adjacent in the circumferential direction X are equal in each pole. As a result, the magnetomotive force distribution is closer to equivalent at each pole. The motor M according to the present example can be regarded as closer to a state in which one type of magnetomotive force distribution is provided.

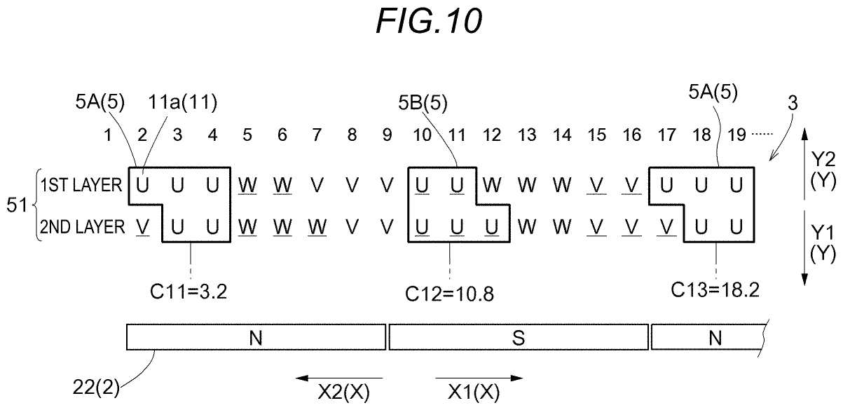

FIG. 10 shows a basic form of a magnetic pole facing state between a phase arrangement of the winding wound around the plurality of slots 32 (basic phase band 5) and the magnetic poles (N pole and S pole) of a pair of rotors 2 in an 8-pole 60-slot motor M.

In the 8-pole 60-slot fractional slot configuration (Nspp=2.5, a=2, b=1, and c=2), the basic phase bands 5 include the first pole basic phase band 5A and the second pole basic phase band 5B respectively facing pairs of adjacent magnetic poles (two poles) among a plurality of magnetic poles (eight poles in the case of the 8-pole 60-slot configuration). The first pole basic phase band 5A and the second pole basic phase band 5B are different from each other in the phase arrangement, and are basic phase bands 5 whose distribution is not uniform.

In the case of the basic form motor M including only the first layer and the second layer shown in FIG. 10, the plurality of (five) coil sides 11a of each basic phase band 5 arranged in the second slot to the fourth slot include one in the second slot, two in the third slot, and two in the fourth slot. The center position C11 of the plurality of coil sides 11a of the basic phase band 5 is 3.2 as shown in the following Formula (16).

C11=(2×1+3×2+4×2)/(1+2+2)=3.2 Formula (16)

Similarly, the center position C12 of the plurality of (five) coil sides 11a of the basic phase band 5 arranged in the 10th slot to the 13th slot is 10.8 as shown in the following Formula (17). The center position C13 of the plurality of (five) coil sides 11a of the basic phase band 5 arranged in the 17th slot to the 19th slot is 18.2 as shown in the following Formula (18).

C12=(10×2+11×2+12×1)/(2+2+1)=10.8 Formula (17)

C13=(17×1+18×2+19×2)/(1+2+2)=18.2 Formula (18)

Based on the above calculation results, in the case of the basic form motor M including only the first layer and the second layer, distances between the centers of the coil sides 11a of the basic phase band 5 of the U phase are C12−C11=7.6, C13−C12=7.4. 7.6 and 7.4 are repeated alternately. That is, the distances among the centers of the coil sides 11a of the basic phase bands 5 of the same phase adjacent in the circumferential direction X are not uniform at each pole.

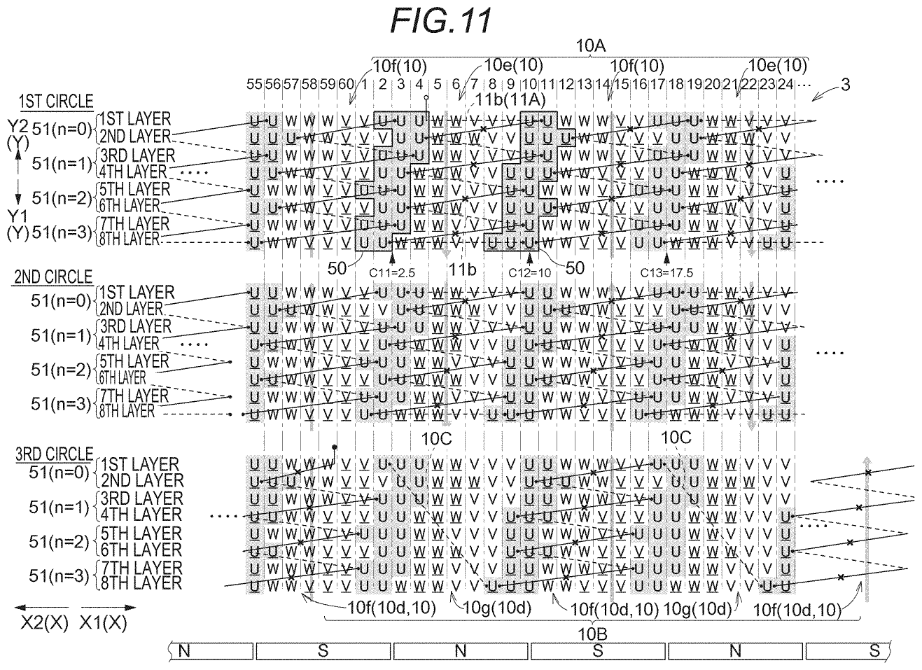

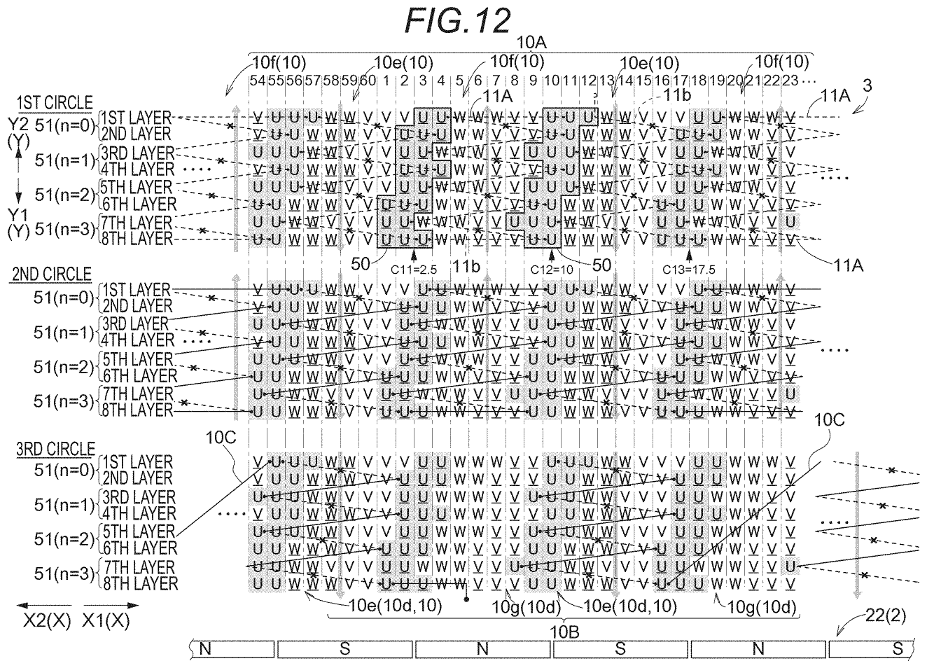

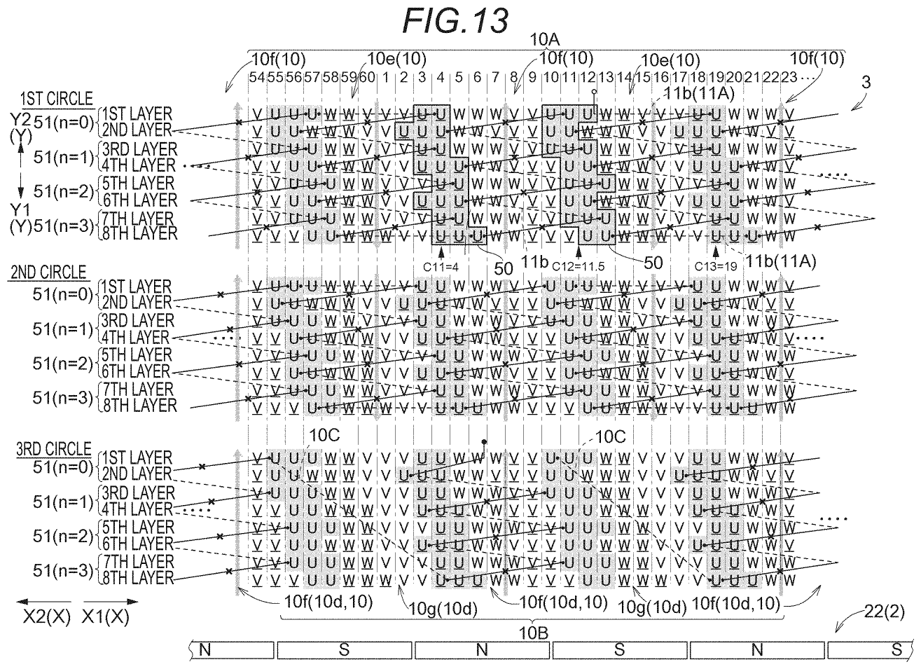

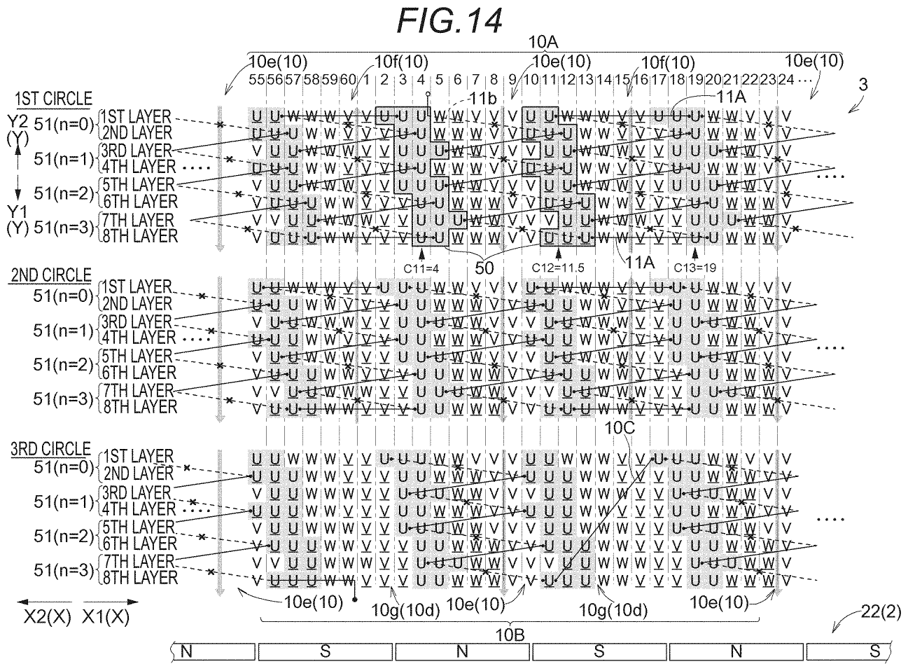

As shown in FIGS. 11 to 14, in the example according to the present embodiment, each of the basic phase band groups 51 is shifted by n times (n is zero or a natural number) a predetermined number of slots in the predetermined direction along the rotation direction X1 with respect to the basic phase band group 51 at the bottom of each slot 32 (n=0). In the case of the fractional slot, the predetermined number of slots is an integer (3×Nspp±1/c) closest to a value (the number of slots per pole) obtained by multiplying the number of slots per pole per phase by three (by the number of phases). In the 8-pole 60-slot fractional slot configuration (Nspp=2.5, a=2, b=1, and c=2), the predetermined number of slots is 7 slots or 8 slots. The predetermined number of slots (shift amount) is 7 slots (short pitch) in the examples of FIGS. 11 and 12. The predetermined number of slots (shift amount) is 8 slots (long pitch) in the examples of FIGS. 13 and 14. In FIG. 12, two layers of each of the four sets of the basic phase band groups 51 shown in FIG. 11 are switched in the radial direction Y to form the phase band arrangement. In FIG. 14, two layers of each of the four sets of the basic phase band groups 51 shown in FIG. 13 are switched in the radial direction Y to form the phase band arrangement.

Further, when n is an odd number (n=1, 3 in the example of FIG. 11), the phase band group arrangement constituted by two layers is reversed in the depth direction (radial direction Y). In the example of FIG. 11, in the basic phase band group 51 of n=1, the basic phase band group 51 of n=0 is shifted in the rotation direction X1 by seven slots and the first layer and the second layer are reversed in the radial direction Y. In the basic phase band group 51 of n=3, the basic phase band group 51 of n=0 is shifted in the rotation direction X1 by 21 slots and the first layer and the second layer are reversed in the radial direction Y. In addition, a mixed phase band 50 in which (n+1) (here, four) basic phase bands 5 are stacked from the radially outward direction Y2 of the slots 32 toward the radially inner direction Y1 is arranged for each pole.

In the examples shown in FIGS. 11 and 12, the plurality of (20) coil sides 11a of the mixed phase band 50 arranged in the first slot to the fourth slot are three in the first slot, seven in the second slot, seven in the third slot, and three in the fourth slot. The center position C11 of the plurality of coil sides 11a of the mixed phase band 50 is 2.5 as shown in the following Formula (19).

C11=(1×3+2×7+3×7+4×3)/(3+7+7+3)=2.5 Formula (19)

Similarly, the center position C12 of the plurality of coil sides 11a of the mixed phase band 50 arranged in the eighth slot to the 12th slot is 10 as shown in the following Formula (20). The center position C13 of the plurality of coil sides 11a of the mixed phase band 50 arranged in the 16th slot to the 19th slot is 17.5 as shown in the following Formula (21).

C12=(8×1+9×5+10×8+11×5+12×1)/(1+5+8+5+1)=10 Formula (20)

C13=(16×3+17×7+18×7+19×3)/(3+7+7+3)=17.5 Formula (21)

In the examples shown in FIGS. 13 and 14, the plurality of (20) coil sides 11a of the mixed phase band 50 arranged in the second slot to the sixth slot are one in the second slot, five in the third slot, eight in the fourth slot, five in the fifth slot, and one in the sixth slot. The center position C11 of the plurality of coil sides 11a of the mixed phase band 50 is four as shown in the following Formula (22).

C11=(2×1+3×5+4×8+5×5+6×1)/(1+5+8+5+1)=4 Formula (22)

Similarly, the center position C12 of the plurality of coil sides 11a of the mixed phase band 50 arranged in the 10th slot to the 13th slot is 11.5 as shown in the following Formula (23). The center position C13 of the plurality of coil sides 11a of the mixed phase band 50 arranged in the 17th slot to the 21st slot is 19 as shown in the following Formula (24).

C12=(10×3+11×7+12×7+13×3)/(3+7+7+3)=11.5 Formula (23)

C13=(17×1+18×5+19×8+20×5+21×1)/(1+5+8+5+1)=19 Formula (24)

As described above, the number of the plurality of coil sides 11a constituting each of the mixed phase bands 50 of the U phase is 20, which is uniform in each pole. Therefore, the magnitude of the magnetomotive force generated when the winding of the stator 3 is energized is uniform in each pole. Further, C12−C11=7.5 and C13−C12=7.5 are satisfied. The distances between the centers of the coil sides 11a of the mixed phase bands 50 of the same phase (U phase) adjacent in the circumferential direction X are equal in each pole. As a result, the magnetomotive force distribution is closer to equivalent at each pole. The motor M according to the present example can be regarded as closer to a state in which one type of magnetomotive force distribution is provided.

As described above, in the examples according to the present embodiment, per-pole rotational symmetry of the magnetomotive force distribution is improved. As a result, in the motor M according to the present embodiment, the vibration causing force of the lower order (fourth order of the spatial deformation mode) is reduced as compared with the order based on the number of magnetic poles (eight poles) of the rotor 2 (eighth order of the spatial deformation mode). Therefore, the rotation rate that coincides with the natural frequency of the stator core 31 increases, and can be set, for example, outside a use rotation rate range. That is, the motor M according to the present embodiment can reduce the noise and the vibration of the motor M by avoiding a resonance opportunity of the rotor 2 within the use rotation rate range.

Next, with reference to FIGS. 11 to 14, the phase band group arrangement of the basic phase band group 51 for implementing the multi-winding configuration of the coils constituted by the segment conductor will be described. In the same drawings, the U phase multi-winding is shown as an example of a winding method for the slots 32 of the winding in the case of the 8-pole 60-slot motor M (Nspp=2.5, a=2, b=1, and c=2). The upper numbers in the drawings indicate the slot numbers. A white circle (see FIG. 11) in the drawing connected to the radially outermost side of the third slot indicates a winding start terminal. A black circle (see FIG. 11) in the drawing connected to the radially outermost side of the substantially 58th slot indicates a winding end terminal. In addition, a cross mark in the drawing indicates a unit coil connection portion in which a pair of unit coils 11 are electrically connected by welding or the like. A solid line indicates a coil end arranged on an upper surface (a front side of a paper surface) of the stator 3. A broken line indicates a coil end arranged on a lower surface (a back side of the paper surface) of the stator 3.

As described above, in the present example, each of the basic phase band groups 51 is shifted by n times (n is zero or a natural number) a predetermined number of slots in the predetermined direction along the rotation direction X1 with respect to the basic phase band group 51 at the bottom of each slot 32 (n=0). When n is an odd number, the phase band group arrangement constituted by two layers is reversed in the depth direction (the radial direction Y).

In the multi-winding configuration of the coils constituted by the segment conductor in the example, the a circles of (two circles, since a=2) coils are constituted by adjacent pole coil groups 10A in each of which pole coils 10 having the same phase at each pole of the magnetic poles of the rotor 2 and having opposite current directions at the adjacent poles of the magnetic poles of the rotor 2, that is, having the same current direction at separated poles (separated by one pole) of the magnetic poles of the rotor 2 are electrically connected in a state of being arranged adjacent to each other. In addition, (a+1)th circle ((a+1)=3) of coils includes the separated pole coil group 10B in which the number of magnetic poles (8 poles) in the circumferential direction X/c (four, since c=2) of the continuous pole coils 10d each including b (b=1) pole coils 10 electrically connected to face c (c=2) magnetic poles are arranged in the circumferential direction X at the separated poles. The continuous pole coils 10d adjacent in the circumferential direction X are electrically connected by the separated pole coil connection portion 10C.

In each adjacent pole coil groups 10A constituting the a circles of (a=2) coils in the multi-winding configuration of the coils shown in FIGS. 11 and 13, the first pole coils 10e including the turn coil ends 11b connecting the same layer in the radial direction Y of the slots 32 and the second pole coils 10f without the turn coil ends 11b connecting the same layer in the radial direction Y of the slots 32 are alternately arranged adjacent to one another in the circumferential direction X. That is, in the adjacent pole coil group 10A, the first pole coils 10e including the turn coil ends 11b connecting the same layer in the radial direction Y of the slots 32 are arranged for each separation pole separated by one pole, and the second pole coils 10f without the turn coil ends 11b connecting the same layer in the radial direction Y of the slots 32 are arranged for each separation pole separated by one pole. Here, “the first pole coils 10e including the turn coil ends 11b connecting the same layer in the radial direction Y of the slots 32” refers to the pole coils 10 having the coil ends (the turn coil ends 11b) connecting the coil sides 11a of the same phase arranged in the first layer (or the eighth layer) in the same layer as shown in FIG. 11.

Further, the turn coil ends 11b connecting the same layer in the radial direction Y of the slots 32 are arranged on a radially outermost side which is the most radially outward direction Y2 of the slots 32 and on the radially innermost side which is the most radially inward direction Y1 of the slots 32.

In the separated pole coil group 10B of the (a+1)th circle ((a+1)=3), the continuous pole coils 10d constituted only by b (b=1) second pole coils 10f without the turn coil ends 11b connecting the same layer in the radial direction Y of the slots 32 are arranged by the number of magnetic poles (8 poles)/c (four, since c=2) separated by one pole in the circumferential direction X. The separated pole coil connection portion 10C electrically connects the number of magnetic poles (8 poles)/c (four, since c=2) of the continuous pole coils 10d. The separated pole coil connection portion 10C electrically connects the first layer on the radially outermost side, which is the most radially outward direction Y2 of the slots 32, and the eighth layer on the radially innermost side, which is the most radially inward direction Y1.

In each adjacent pole coil group 10A constituting the a circles of (a=2) coils in the multi-winding configuration of the coils shown in FIGS. 12 and 14, the first pole coils 10e which are arranged on the radially outermost side which is the most radially outward direction Y2 of the slots 32 and on the radially innermost side which is the most radially inward direction Y1 of the slots 32 and are not interposed between the pair of adjacent pole coil connection portions 11A electrically connecting the adjacent pole coils 10 and the second pole coils 10f interposed between the pair of adjacent pole coil connection portions 11A are alternately arranged in the circumferential direction X. That is, in the adjacent pole coil group 10A, the first pole coils 10e including only the pole coils 10 without the adjacent pole coil connection portion 11A that connects the same layer in the radial direction Y of the slots 32 are arranged for each separated pole separated by one pole, and the second pole coils 10f including the adjacent pole coil connection portion 11A that connects the same layer in the radial direction Y of the slots 32 are arranged for each separated pole separated by one pole.

The separated pole coil group 10B of the (a+1)th circle ((a+1)=3) includes only the first pole coils 10e that are not interposed between the pair of adjacent pole coil connection portions 11A. A plurality of continuous pole coils 10d constituted only by b (b=1) first pole coils 10e not interposed between the pair of adjacent pole coil connection portions 11A are arranged to be separated by one pole in the circumferential direction X. The separated pole coil connection portion 10C electrically connects the number of magnetic poles (8 poles)/c (four, since c=2) of the continuous pole coils 10d. The separated pole coil connection portion 10C electrically connects the eighth layer on the radially innermost side, which is the most radially inward direction Y1 of the slots 32, and the first layer on the radially outermost side, which is the most radially outward direction Y2 of the slots 32.

Summarizing the above, in the phase coil configuration in the present example, the configuration in which the pole coils 10 adjacent in the circumferential direction X are electrically connected by an adjacent pole coil connection portion 11A make a circles in the rotation direction X1, and subsequently, b continuous pole coils 10d are electrically connected by the separated pole coil connection portion 10C while skipping (c−b) poles per c continuous poles, and makes one circle in the rotation direction X1. According to the configuration, the adjacent pole coil group 10A or the separated pole coil group 10B of the second and subsequent circles is shifted by one slot pitch in the direction (reverse rotation direction X2) opposite to the circling direction (rotation direction X1) with respect to the adjacent pole coil group 10A on the previous circle.

According to the above specification, since the turn coil ends 11b other than the same-layer connection portion are inclined or bent by one layer from the radially outer side to the radially inner side in the rotation direction X1, the unit coil connection portion in which the pair of unit coils 11 are electrically connected by welding or the like can be visually recognized without interfering with other coils. Accordingly, after all the coil sides 11a of the unit coils 11 constituted by the three-phase segment conductor of the U phase, the V phase, and the W phase are inserted into the slots 32, work of connecting the pair of unit coils 11 by welding or the like becomes extremely easy.

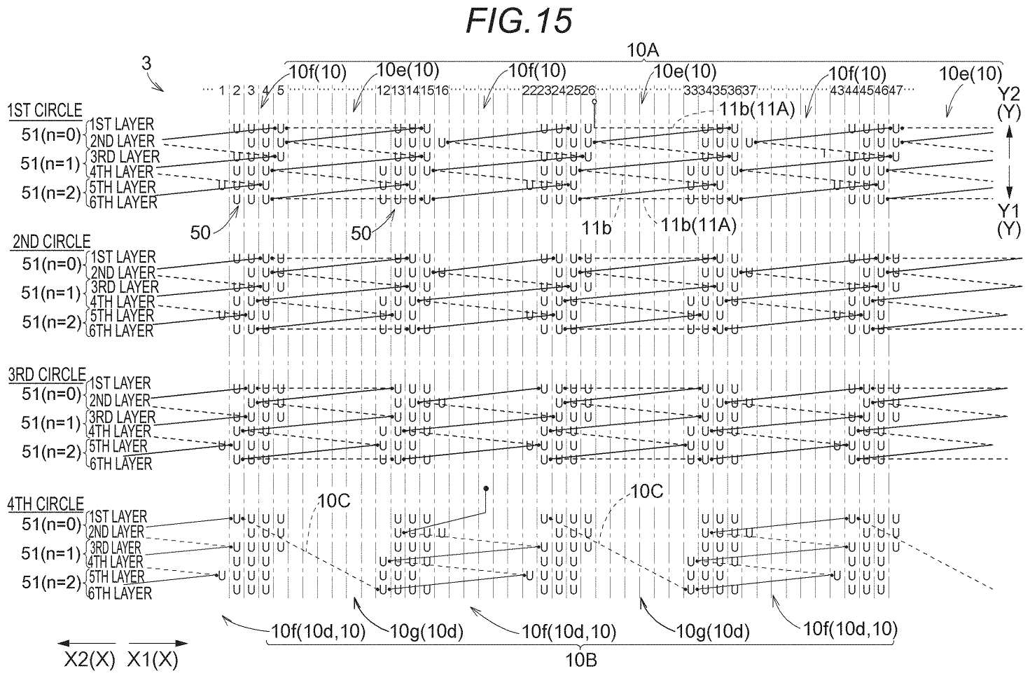

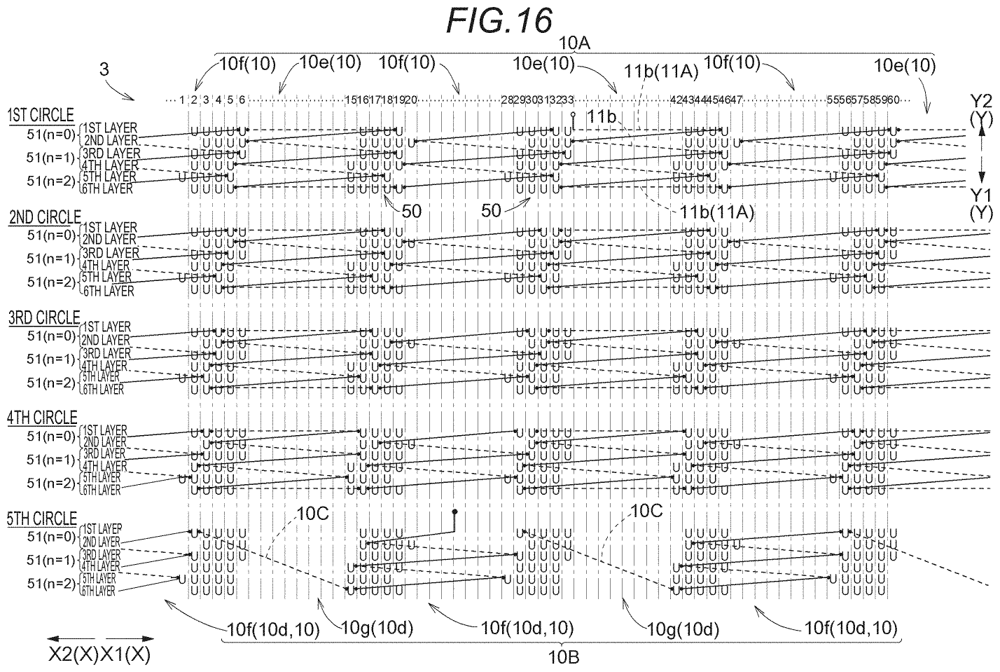

Hereinafter, with reference to FIGS. 15 and 16, the phase arrangement example and the winding configuration example in the motor M having the fractional slot configuration whose denominator is 2 and Nspp=3.5 and 4.5 when the number of slots per pole per phase is expressed as the irreducible fraction will be described. The upper numbers in the drawing indicate the slot number. The white circle in the drawing indicates the winding start terminal. The black circles in the drawing indicate the winding end terminal. In addition, the solid line indicates a coil end arranged on an upper surface (a front side of a paper surface) of the stator 3. The broken line indicates a coil end arranged on a lower surface (a back side of the paper surface) of the stator 3.

FIG. 15 shows the winding configuration of an 8-pole 84-slot motor M (Nspp=3.5, a=3, b=1, and c=2). In the 8-pole 84-slot motor M, the number of slots per pole is 10.5. Therefore, the short pitch is 10 slots (short-pitch winding) or the long pitch is 11 slots (long-pitch winding). Similarly to the above described example, in the n basic phase band groups 51, the basic phase band group 51 with n=0 is shifted by n times the predetermined number of slots (10 slots in the example of FIG. 15) in the rotation direction X1 of the rotor 2. When n is an odd number, each layer is inverted in the radial direction Y.

In the present example, the plurality of (21) coil sides 11a of the mixed phase band 50 arranged in the first slot to the fifth slot are one in the first slot, five in the second slot, six in the third slot, six in the fourth slot, and three in the fifth slot. The center position C11 of the plurality of coil sides 11a of the mixed phase band 50 is 68/21 as shown in the following Formula (25).

C11=(1×1+2×5+3×6+4×6+5×3)/(1+5+6+6+3)=68/21 Formula (25)

Similarly, the center position C12 of the plurality of coil sides 11a of the mixed phase band 50 arranged in the 12th slot to the 16th slot is 289/21 as shown in the following Formula (26). The center position C13 of the plurality of coil sides 11a of the mixed phase band 50 arranged in the 22nd slot to the 26th slot is 509/21 as shown in the following Formula (27).

C12=(12×3+13×6+14×6+15×5+16×1)/(3+6+6+5+1)=289/21 Formula (26)

C13=(22×1+23×5+24×6+25×6+26×3)/(1+5+6+6+3)=509/21 Formula (27)

As described above, the number of the plurality of coil sides 11a constituting each of the mixed phase bands 50 of the U phase is 21, which is uniform in each pole. Therefore, the magnitude of the magnetomotive force generated when the winding of the stator 3 is energized is uniform in each pole. Further, C12−C11=221/21, and C13−C12=220/21 are satisfied. As compared with the basic form motor M including only the first and second layers (center (19/7, 93/7, 166/7), center-to-center distance (74/7, 73/7)), the per-pole rotational symmetry of the magnetomotive force distribution is improved, and the noise and vibration of the motor M can be reduced.

As shown in FIG. 15, the a circles (a=3) coils are constituted by the adjacent pole coil groups 10A in each of which the pole coils 10 having the same phase at each pole of the magnetic poles of the rotor 2 and having the opposite current directions at the adjacent poles of the magnetic poles of the rotor 2, that is, having the same current direction at separated poles (separated by one pole) of the magnetic poles of the rotor 2 are electrically connected in the state of being arranged adjacent to each other. In addition, (a+1)th circle ((a+1)=4) of coils includes the separated pole coil group 10B in which the number of magnetic poles (8 poles) in the circumferential direction X/c (four, since c=2) of the continuous pole coils 10d including b (b=1) pole coils 10 electrically connected to face c (c=2) magnetic poles are arranged in the circumferential direction X at the separated poles. The continuous pole coils 10d adjacent in the circumferential direction X are electrically connected by the separated pole coil connection portion 10C.

In each adjacent pole coil group 10A constituting the a circles (a=3) of coils, first pole coils 10e including the turn coil ends 11b connecting the same layer in the radial direction Y of the slots 32 and second pole coils 10f without the turn coil ends 11b connecting the same layer in the radial direction Y of the slots 32 are alternately arranged adjacent to one another in the circumferential direction X. Further, in the pole coils 10, in the unit coils 11 other than the same-layer connection portion, the turn coil end 11b is formed at a short pitch inclined by one layer from the radially outer side to the radially inner side in the rotation direction X1. Further, the turn coil ends 11b connecting the same layer in the radial direction Y of the slots 32 are arranged on a radially outermost side of the slots 32 and on the radially innermost side of the slots 32.

In the separated pole coil group 10B of the (a+1)th circle ((a+1)=4), the continuous pole coils 10d constituted only by b (b=1) second pole coils 10f without the turn coil ends 11b connecting the same layer in the radial direction Y of the slots 32 are arranged by the number of magnetic poles (8 poles)/c (four, since c=2) separated by one pole in the circumferential direction X. The separated pole coil connection portion 10C electrically connects the radially outermost side layer and the radially innermost side layer of the slots 32 in each of the number of magnetic poles (8 poles)/c (four, since c=2) of the continuous pole coils 10d. In addition, the separated pole coil group 10B of the second and subsequent circles is shifted by one slot pitch in the direction opposite to the circling direction with respect to the adjacent pole coil group 10A of the previous circle (first circle).

FIG. 16 shows a winding configuration of an 8-pole 108-slot motor M (Nspp=4.5, a=4, b=1, and c=2). In the 8-pole 108-slot motor M, the number of slots per pole is 13.5. Therefore, the short pitch is 13 slots (short-pitch winding) or the long pitch is 14 slots (long-pitch winding). Similarly to the above described example, in the n basic phase band groups 51, the basic phase band group 51 with n=0 is shifted by n times the predetermined number of slots (13 slots in the example of FIG. 16) in the rotation direction X1 of the rotor 2. When n is an odd number, each layer is inverted in the radial direction Y.

In the present example, the plurality of (27) coil sides 11a of the mixed phase band 50 arranged in the first slot to the fifth slot are one in the first slot, five in the second slot, six in the third slot, six in the fourth slot, six in the fifth slot, and three in the sixth slot. The center position C11 of the plurality of coil sides 11a of the mixed phase band 50 is 101/27 as shown in the following Formula (28).

C11=(1×1+2×5+3×6+4×6+5×6+6×3)/(1+5+6+6+5+3)=101/27 Formula (28)

Similarly, the center position C12 of the plurality of coil sides 11a of the mixed phase band 50 arranged in the 15th slot to the 20th slot is 466/27 as shown in the following Formula (29). The center position C13 of the plurality of coil sides 11a of the mixed phase band 50 arranged in the 28th slot to the 33rd slot is 830/27 as shown in the following Formula (30).

C12=(15×3+16×6+17×6+18×6+19×5+20×1)/(3+6+6+6+5+1)=466/27 Formula (29)

C13=(28×1+29×5+30×6+31×6+32×6+33×3)/(1+5+6+6+5+3)=830/27 Formula (30)

As described above, the number of the plurality of coil sides 11a constituting each of the mixed phase bands 50 of the U phase is 27, which is uniform in each pole. Therefore, the magnitude of the magnetomotive force generated when the winding of the stator 3 is energized is uniform in each pole. Further, C12−C11=365/27, and C13−C12=364/27 are satisfied. As compared with the basic form motor M (center (29/9, 151/9, 272/9), center-to-center distance (122/9, 121/9)) including only the first to second layers, the per-pole rotational symmetry of the magnetomotive force distribution is improved, and the noise and vibration of the motor M can be reduced.

As shown in FIG. 16, the a circles (a=4) coils are constituted by the adjacent pole coil groups 10A in each of which the pole coils 10 having the same phase at each pole of the magnetic poles of the rotor 2 and having the opposite current directions at the adjacent poles of the magnetic poles of the rotor 2, that is, having the same current direction at separated poles (separated one pole) of the magnetic poles of the rotor 2 are electrically connected in the state of being arranged adjacent to each other. In addition, the (a+1)th circle ((a+1)=5) of coils includes a separated pole coil group 10B in which the number of magnetic poles (8 poles) in the circumferential direction X/c (four, since c=2) of the continuous pole coils 10d including b (b=1) pole coils 10 electrically connected to face c (c=2) magnetic poles are arranged in the circumferential direction X at the separated poles. Each of the continuous pole coils 10d adjacent in the circumferential direction X is electrically connected by a separated pole coil connection portion 10C.

In each adjacent pole coil group 10A constituting the a circles (a=4) of coils, first pole coils 10e including the turn coil ends 11b connecting the same layer in the radial direction Y of the slots 32 and second pole coils 10f without the turn coil ends 11b connecting the same layer in the radial direction Y of the slots 32 are alternately arranged adjacent to one another in the circumferential direction X. Further, in the pole coils 10, in the unit coils 11 other than the same-layer connection portion, the turn coil end 11b is formed at a short pitch inclined by one layer from the radially outer side to the radially inner side in the rotation direction X1. Further, the turn coil ends 11b connecting the same layer in the radial direction Y of the slots 32 are arranged on a radially outermost side of the slots 32 and on the radially innermost side of the slots 32.

In the separated pole coil group 10B of the (a+1)th circle ((a+1)=5), the continuous pole coils 10d constituted only by b (b=1) second pole coils 10f without the turn coil ends 11b connecting the same layer in the radial direction Y of the slots 32 are arranged by the number of magnetic poles (8 poles)/c (four, since c=2) with one pole separated in the circumferential direction X. The separated pole coil connection portion 10C electrically connects the radially outermost side layer and the radially innermost side layer of the slots 32 in each of the number of magnetic poles (8 poles)/c (four, since c=2) of the continuous pole coils 10d. In addition, the separated pole coil group 10B of the second and subsequent circles is shifted by one slot pitch in the direction opposite to the circling direction with respect to the adjacent pole coil group 10A of the previous circle (first circle).

The motor M in the above described embodiment is not limited to the three-phase AC synchronous motor, and may be an AC motor, an induction motor, a synchronous motor, or the like having any number of phases, or may be a linear motor.

### INDUSTRIAL APPLICABILITY

The present invention can be applied to a rotary electric machine having a fractional slot configuration including a coil formed of segment conductors.

A characteristic configuration of a rotary electric machine according to the present disclosure resides in that the rotary electric machine includes: a stator having a plurality of slots in each of which coils formed of segment conductors and having a multi-winding configuration are accommodated; and a rotor having a plurality of magnetic poles and facing the stator. The rotary electric machine having a fractional slot configuration in which the number of slots per pole per phase obtained by dividing the number of slots of the stator by the number of phases and the number of magnetic poles of the rotor is expressed as an irreducible fraction whose denominator is 2. When a circumferential direction of the stator having the same position in a depth direction in the slot is regarded as one layer, and a band of slots that are adjacent in the circumferential direction and are occupied by coil sides of the coils of the same phase having the same current direction in two layers adjacent in the depth direction is regarded as a basic phase band, a plurality of basic phase band groups are arranged in parallel from a bottom to an opening of each slot, the basic phase band groups each including basic phase bands arranged for each pole and each having different phases in a rotation direction of the rotor, and each of the basic phase band groups is shifted by n times (n is zero or a natural number) a predetermined number of slots in a predetermined direction along the rotation direction with respect to the basic phase band group at the bottom of each slot. When n is an odd number, a phase band group arrangement constituted by two layers is reversed in the depth direction.

According to the configuration, it is possible to implement a rotary electric machine having a fractional slot configuration using a segment conductor with a multi-winding configuration. In addition, according to the configuration, since the attractive force distribution in each pole of the magnetic poles of the rotor is uniform as compared with a basic form rotary electric machine including only the first layer and the second layer, it is possible to reduce the noise and the vibration.

Another characteristic configuration resides in that the basic phase band groups are arranged in parallel in the depth direction from the bottom to the opening such that n is in an ascending order or a descending order.

According to this configuration, since the attractive force distribution in each pole of the magnetic poles of the rotor is uniform as compared with the basic form rotary electric machine including only the first layer and the second layer, it is possible to reduce the noise and the vibration.

Another characteristic configuration resides in that the predetermined number of slots is an integer closest to the number of slots per pole obtained by multiplying the number of slots per pole per phase by the number of phases.

When the predetermined number of slots is defined as in this configuration, when a coil pitch is either a short pitch or a long pitch, it is possible to implement a rotary electric machine having a fractional slot configuration using a segment conductor with a multi-winding configuration and to reduce noise and vibration.

Another characteristic configuration resides in that, when an irreducible mixed fraction expression of the number of slots per pole per phase is a+b/c (a is zero or a positive integer, b and c are positive integers, and b<c), each of a circles of the coils are configured with an adjacent pole coil group in which, in a state in which a number of pole coils the same as the number of magnetic poles of the rotor are arranged adjacent to each other on an entire circumference of the stator, pole coils adjacent in the circumferential direction are sequentially and electrically connected. An (a+1)th circle of the coils is configured with a separated pole coil group in which each range obtained by equally dividing the entire circumference into the number of magnetic poles/c is provided with a continuous pole coil in which b pole coils and (c−b) pole coil missing portions formed of blanks corresponding to the pole coils are sequentially adjacent to each other and pole coils closest to each other in the circumferential direction are electrically connected, and the number of magnetic poles/c of the continuous pole coils adjacent in the circumferential direction are electrically connected between separated poles so as to circle.

According to the configuration, it is possible to implement a rotary electric machine having a fractional slot configuration using a segment conductor with a multi-winding configuration.

Another characteristic configuration resides in that the adjacent pole coil group of second and subsequent circles or the separated pole coil group is shifted by one slot pitch in a direction opposite to a circling direction with respect to the adjacent pole coil group on a previous circle.

According to this configuration, coil ends are evenly arranged, and compactness can be achieved.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A rotary electric machine comprising:
a stator having a plurality of slots in each of which coils formed of segment conductors and having a multi-winding configuration are accommodated; and
a rotor having a plurality of magnetic poles and facing the stator,
the rotary electric machine having a fractional slot configuration in which the number of slots per pole per phase obtained by dividing the number of slots of the stator by the number of phases and the number of magnetic poles of the rotor is expressed as an irreducible fraction whose denominator is 2, wherein
when a circumferential direction of the stator having the same position in a depth direction in the slot is regarded as one layer, and a band of slots that are adjacent in the circumferential direction and are occupied by coil sides of the coils of the same phase having the same current direction in two layers adjacent in the depth direction is regarded as a basic phase band,
a plurality of basic phase band groups are arranged in parallel from a bottom to an opening of each slot, the basic phase band groups each including basic phase bands arranged for each pole and each having different phases in a rotation direction of the rotor, and
each of the basic phase band groups is shifted by n times (n is zero or a natural number) a predetermined number of slots in a predetermined direction along the rotation direction with respect to the basic phase band group at the bottom of each slot, and, when n is an odd number, a phase band group arrangement constituted by two layers is reversed in the depth direction.

2. The rotary electric machine according to claim 1, wherein
the basic phase band groups are arranged in parallel in the depth direction from the bottom to the opening such that n is in an ascending order or a descending order.

3. The rotary electric machine according to claim 1, wherein
the predetermined number of slots is an integer closest to the number of slots per pole obtained by multiplying the number of slots per pole per phase by the number of phases.

4. The rotary electric machine according to claim 3, wherein
when an irreducible mixed fraction expression of the number of slots per pole per phase is a+b/c (a is zero or a positive integer, b and c are positive integers, and b<c),
each of a circles of the coils are configured with an adjacent pole coil group in which, in a state in which a number of pole coils the same as the number of magnetic poles of the rotor are arranged adjacent to each other on an entire circumference of the stator, pole coils adjacent in the circumferential direction are sequentially and electrically connected, and
an (a+1)th circle of the coils is configured with a separated pole coil group in which each range obtained by equally dividing the entire circumference into the number of magnetic poles/c is provided with a continuous pole coil in which b pole coils and (c−b) pole coil missing portions formed of blanks corresponding to the pole coils are sequentially adjacent to each other and pole coils closest to each other in the circumferential direction are electrically connected, and the number of magnetic poles/c of the continuous pole coils adjacent in the circumferential direction are electrically connected between separated poles so as to circle.

5. The rotary electric machine according to claim 4, wherein
the adjacent pole coil group of second and subsequent circles or the separated pole coil group is shifted by one slot pitch in a direction opposite to a circling direction with respect to the adjacent pole coil group on a previous circle.
